(19) United States
(12) Patent Application Publication
(10) Pub. No.: US 2021/0233006 A1
(43) Pub. Date: Jul. 29, 2021

(54) Method and System for Managing Vehicle Transportation Between Dealers

(71) Applicant: Louis Labbe, St-Jacques-le-Mjr-d-Wolfestown (CA)

(72) Inventor: Louis Labbe, St-Jacques-le-Mjr-d-Wolfestown (CA)

(21) Appl. No.: 17/059,332

(22) PCT Filed: May 28, 2019
(86) PCT No.: PCT/CA2019/050723

§ 371 Date: Nov. 27, 2020

Related U.S. Application Data
(60) Provisional application No. 62/677,135, filed on May 28, 2018.

(51) Int. Cl. G06Q 10/06; G06Q 10/08; G06Q 20/08; G06Q 30/04

(52) U.S. Cl. CPC G06Q 10/06315; G06Q 10/0835; G01C 21/3407; G06Q 10/0837; G06Q 30/04; G06Q 20/085

(57) ABSTRACT

A method and system for managing vehicles transportation involving multiple vehicle dealers and the transport of at least two vehicles. The method comprises a receiving dealer located in a first area requiring a transport of a vehicle and a sending dealer located in a second area providing the vehicle. The system and method matching the transport with one ore more other transport between one or more receiving dealers and one or more sending dealer. The method pairs the different dealers and assign a driver to drive the vehicles to be delivered between the paired dealers. The method further organizes the transport of the driver between a receiving and sending dealers of the same predetermined area. A system provides access and input information, confirmation numbers, delivery confirmation, automatic processing of payments, driving instructions and details about the transport.

### CROSS-REFERENCE TO RELATED APPLICATIONS

The present patent application claims the benefits of priority of U.S. Provisional Patent Application No. 62/677,135, entitled “METHOD AND SYSTEM FOR MANAGING VEHICLE TRANSPORTATION BETWEEN DEALERS” and filed at the United States Patent and Trademark Office on May 28, 2018.

### FIELD OF THE INVENTION

The present invention generally relates to methods and systems for managing the transportation of vehicles. More specifically, the present invention relates to methods and systems for managing and pairing transport of vehicles between dealers.

### BACKGROUND OF THE INVENTION

Car dealers often sell vehicles which are not in-stock as car buyers may wish specific mechanic, options, colors, etc. To fulfill the needs of the car buyer, the car dealer typically looks into inventory of near-by car dealers to identify available cars having the required options. When a vehicle is identified, the car dealer buys the car from the near-by car dealer to quickly deliver the vehicle to the car buyer.

To deliver the vehicle, the near-by car dealer will hire two drivers, one for a first car to be delivered and one for a second car to provide a transport back to the near-by car dealer. The two cars are driven to the car dealer and, upon delivery of the first car, the two drivers return to the near-by car dealer in the second car. Understandably, the transport may sometimes be in the opposite direction such as the two drivers driving a car to the near-by car dealer and returning with the first and second cars.

Some systems and methods exist for optimizing the delivery from manufacturing sites to dealers and in between dealers to minimize inventory. As an example, U.S. Pat. No. 6,847,941 B2 describes a method and system managing arrangements and negotiations with respect to dealers free and non-free inventories in order for ease vehicle exchanges between dealers. However, such systems do not provide a solution for managing the actual transfer of the exchanged vehicles between dealers.

Other methods and systems relating to transport logistics exist such as U.S. Pat. No. 6,879,962 B1 and US Patent Application No. US 2002/0138360 A1. Such documents provide solution to the optimization of product distribution by updating logistic information such as materials, vendors, transports and delivery locations in order to facilitate cost-effective solutions. Nonetheless, such documents do not describe an inter-dealer vehicle exchange or how a product is delivered. Other methods and systems, such as US Patent Application No. US 2006/0195385 A1, describe exchanging products between companies through bidding. Again, no mention is made on how the exchange takes place or how the products are delivered.

Thus, there is a need for an improved method and system for managing vehicle transportation between dealers overcoming the drawback of the prior art solutions.

### SUMMARY OF THE INVENTION

The shortcomings of the prior art are generally mitigated by a method and system for managing vehicle transportation between dealers.

In one aspect of the invention, a method and system for managing vehicle transportation between dealer aims at reducing driving time used to transport a vehicle from one dealer to another. Benefits may comprise reducing fuel consumption, vehicle wear and tear and risks of accidents as less time is spent on the road. Furthermore, such reductions may ultimately lead to reduced costs of operation, increased safety and a reduction in the greenhouse gas emissions to the atmosphere due to the use of fossil fuels. Such method and system further aim at reducing the number of trips or segments required to transport a vehicle. As an example, a typical vehicle transportation requires three trips (two in one direction and one (1) in the opposite direction).

Within the present document, the terms cars and vehicles are used interchangeably to refer to any type of vehicles, such as but not limited to a car, a truck, a

SUV, any all-terrain vehicle, such a side-by-side, a snowmobile, a bus, etc.

The term city or location are used interchangeably and refers to a location within a predetermined radius or any predetermined area, such as a city, a town, a square, a neighborhood, a county, a quarter, etc.

A method and system for managing vehicle transportation between dealers is provided. The method comprises managing vehicle transportation between at least four car dealers or at least six car dealers. The method for managing vehicle transportation between four car dealers comprises a first car dealer located in a first city requiring a car to fulfill the needs of a customer. The first car dealer typically agrees with a second car dealer located in a second city having such car for sale in order for a pairing to occur comprising inputting the details and specifications about the car to be delivered along with the location of the first car dealer and of the second car dealer in addition to the transport date. The transport information and pairing may also be accessible to other car dealers. A third car dealer located in the second city may then require the transport of a vehicle from a fourth car dealer located in the first city. The third car dealer typically agrees with the fourth car dealer located in the first city having such car for sale allowing the pairing between the third car dealer and the fourth car dealer to create a transport. The method encompasses matching transports that have opposite origin and destinations within a predetermined radius in order to formalize a pairing. Furthermore, a unique confirmation or transport number may be generated to validate that the cars have been received and the payments are made.

Additionally, drivers may be transported between dealers located in the same city by a shuttle provided by the second or third dealer, a taxi or any other type of transportation to bring the driver back to original car dealer. This transport allows using a single driver and to avoid using two drivers and both dealers may agree on the transportation mode when the pairing is finalized.

In fact, the method may also comprise automatically processing the payments and disbursements associated with the transport. The method may also comprise returning the temporary licence plates to their respective owners/dealers by generating and/or printing a pre-addressed envelope or box. Such envelope or box is returned back to the owner/dealer. Typically, the licence plate is a special licence plate which may be easily removed and used in multiple vehicles to allow driving new or unlicensed vehicles on the road.

The method may also comprise managing vehicle transportation between dealers located in three cities and may be adapted to manage transportation in more than three cities. As such, the method may comprise managing at least three transports or trips, at least three cities and at least three vehicles following the principles and steps already identified in the pairing among four car dealers. The method comprising car dealers agreeing to buy a car fulfilling the needs of customers to the car dealer having the required cars. The method comprises matching destinations and origins as per the following: the first trip destination being the same as the second trip origin, the second trip destination being the same as the third trip origin, and the third trip destination being the same as the first trip origin. When all conditions are matching, the transports are matched to create a formalized pairing of the three trips. The method further comprises pairing the three transports. Again, confirmation numbers may be issued to confirm car delivery and process payments, and licence plates may be expedited or sent back to the respective sending car dealers using any known method, such as mailing, courier or another driver returning the plate to the sending dealers which may further comprise printing a pre-addressed envelope or box for each sending car dealer. Also, a transport may be used by the driver between the location of the last receiving dealer and the location of the first sending dealer, upon agreement between dealers at the time of pairing, such as a shuttle provided by the receiving dealer to the next sending dealer or, a taxi or any other types of transportation for the same purpose as mentioned earlier, to allow using a single driver and to avoid using multiple drivers for completing the complete trip. The steps are then repeated for each transport. The driver may then collect a vehicle left or present at the first sending dealer or may take another shuttle or any other public transit to go to another destination.

The present invention also comprises a system for managing vehicle transportation between dealers. The system comprising a server to connect to client devices through a network and being configured to manage vehicle transportation between dealers. The server may comprise a central processor unit, a memory unit, a storage unit and a network unit. A computerized device may be adapted to connect to the server through the network in order to send requests to the server or to run a program, such as a mobile application or a browser, to communicate with the server. This device may provide an interface for a user to enter the information related to a transport and to communicate with the server as well as to enter a confirmation number. The system may also be configured to communicate driving instructions, details about the transport, the unique identification number, and to display or publish the driving instructions between a sending car dealer and a receiving car dealer of a transport or to provide localization data.

Furthermore, the system may be configured to automatically match two or more transports having compatible origins and destinations. The system may be further configured to pair matching transports, to generate confirmation numbers, to process payments, to generate invoices, to validate confirmation numbers and to generate confirmation receipts.

In one aspect of the invention, a computer-implemented method for managing delivery of vehicles between dealers of vehicles is provided. The method comprises a first dealer at first location communicating first criteria about a vehicle to be delivered to the first dealer to a server, sending a notification to the first dealer that a second dealer at a second location is in possession of a first matching the entered criteria, pairing the first dealer and the second dealer to create a first delivery, a third dealer within a first predetermined distance from the second location communicating second criteria about a vehicle to be delivered to the third dealer to a server, sending a notification to the third dealer that a fourth dealer within a second predetermined distance from the first location is in possession of a second vehicle matching the entered second criteria, pairing the third dealer and the fourth dealer to create a second delivery, pairing the first delivery to the second delivery to create a transport and associating a driver to the created transport.

The first and second criteria may respectively comprise specifications of the first and second cars to be delivered, location information of first and the third dealers and/or a transport date. The information relating to the first and second deliveries may be available to all dealers.

The method may further comprise generating a unique confirmation identification for each of the deliveries or for the transport and/or creating a driver delivery between the fourth and the first dealer. The driver delivery may be associated with a mode of transportation. The method may further comprise creating a driver delivery between the first and the third dealer.

The method may further comprise automatically processing the payments and disbursements associated with the transport. The method may further comprise generating a pre-addressed label to return one or more temporary licence plates used in the transport to the respective dealers. automatically processing the payments and disbursements associated with the transport.

In another aspect of the invention, a system for managing delivery of vehicles between dealers is provided. The system comprises a plurality of computerized devices adapted to communicate through a network, each computerized device being configured to provide an interface for a user, input criteria about a vehicle to be delivered to a dealer, to receive notifications. The system further comprises a data source configured to store a plurality of dealers, each dealer being associated with a location and details, a plurality of deliveries, each delivery pairing an origin dealer, a destination dealer and a vehicle to be delivered and a plurality of transports, each transport pairing at least a first delivery and a second delivery;

The system further comprises a server configured to communicate through the network, the server is configured to automatically match two or more deliveries where a location of an origin dealer of a first delivery is within a predetermined distance of a destination location of a second delivery, pair the matching deliveries to form a transport, generate unique confirmation numbers for each delivery or each paired transport, send notifications to one or more of the computerized devices when a dealer is in possession of a vehicle matching at least one of the inputted criteria.

The server may further be configured to process payments and to generate invoices in relation to each delivery and to the transport.

The server may further be configured to validate one or more confirmation numbers inputted in one of the computerized devices and communicated to the server.

The server may further be configured to calculate driving instructions in relation to at least one of the deliveries to at least one of the computerized devices. The server may further be configured to communicate the driving instructions to at least one of the computerized devices. The server may further be configured to automatically match two or more deliveries having origins and destinations within a predetermined distance.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a pairing of two inter-dealer trips involving two vehicles, two trips and four dealers.

FIG. 2 is a pairing of three inter-dealer trips involving three vehicles, three trips and six dealers.

### DETAILED DESCRIPTION OF THE PREFERRED EMBODIMENT

A novel method and system for managing vehicle transportation between dealers will be described hereinafter. Although the invention is described in terms of specific illustrative embodiments, it is to be understood that the embodiments described herein are by way of example only and that the scope of the invention is not intended to be limited thereby.

The method and system for managing vehicle transportation between dealers generally allows pairing vehicle dealers requiring transport of vehicle between similar or compatible destinations.

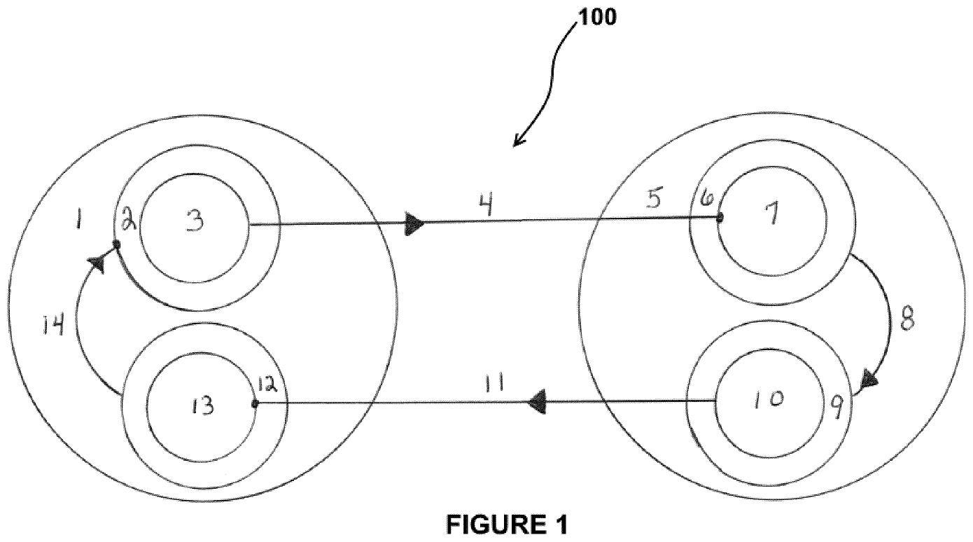

Now referring to FIG. 1, an exemplary method 100 for managing vehicle transportation between four car dealers is illustrated. In such a method 100, a first car dealer 6 located in a first city 5 requires a car 3 fulfilling the needs of a customer. The first car dealer 6 typically agrees with a second car dealer 2 located in a second city 1 having such car 3 for sale.

The method 100 comprises pairing the first car dealer 6 to the second car dealer 2. The pairing typically comprises inputting the details about the car 3 to be delivered, such as the type of car, the color, the model, the serial number, etc. The pairing further comprises inputting the location of or identifying the first car dealer 6 and of the second car dealer 2 and the date at which the transport is required, typically the deadline date for transport. The method may further comprise cancelling or suspending the transport if the transport is no longer required.

The method 100 further comprises publishing or displaying the transport information for other car dealers to access the planned transport.

In such an exemplary embodiment, a third car dealer 12 located in the second city 1 also required the transport of a vehicle 10 from a fourth car dealer 9 located in the first city 5. The third car dealer 12 typically agrees with the fourth car dealer 9 located in the first city 5 having such car 10 for sale. The method 100 further comprises pairing the third car dealer 12 to the fourth car dealer 9 and creating a transport 11 as explained above.

The method 100 further comprises matching that the transport 4 has an origin 1 with a predetermined radius of the destination 1 of the transport 11. The method 100 also identifies that the transport 4 has a destination 5 within a predetermined radius of the origin 5 of the transport 11. When both conditions are matching, the transports 4 and 11 are matched to create a formalized pairing.

Understandably, the predetermined radius may be replaced with a predetermined travel or commuting distance or by a travel or commuting time. In such embodiments, the server may further be configured to calculate the distance to travel using the vehicle or the travel time using the vehicle. Additionally, traffic data or averages of traffic data may be used to better estimate the travel time of a driver between dealers. The calculation of time of travel or distance of travel may also be executed by third-party services.

In some embodiments, the method 100 may further comprise generating or issuing a unique confirmation or transport number. The confirmation number may be used to validate that the car 3 received by the first dealer 6 is the car 3 associated with the transport 4. Such unique number may also be used to identify the payment and disbursement agreements involved in the vehicle transfer.

The driver drives the vehicle 3 from the second dealer 2 to the first dealer 6. Upon arrival, the driver shows or indicates the unique number to the receiving car dealer 6.

The method 100 may further comprise the receiving car dealer 6 inputting the unique number in the system to confirm that the vehicle 3 has been received. The method 100 may further comprise generating a receipt or a confirmation of delivery for the driver. The method 100 may also comprise automatically processing the payments and disbursements associated with the transport.

Typically, the driver may also keep the license plate of the vehicle 3 as such license plate is generally owned by the second dealer 2.

The method 100 further comprises managing the transportation 8 of the driver from the first dealer 6 to the fourth dealer 9. In some embodiment, the method 100 comprises requesting a transport between the location of the first dealer 6 and the location of the fourth dealer 9. Understandably, any method 100 for 8 may be used such as a shuttle 8 provided by the first dealer 6 or fourth dealer 9, a taxi or any other types of transportation. The transportation 8 allows using a single driver and to avoid using two drivers. The method 100 may comprise the first and second dealers agreeing on a transportation mode which is identified in the system when the pairing is formalized.

The method 100 further comprises the driver showing or providing the unique number or any other proof to the fourth dealer upon arrival from the transport 8. The method 100 may further comprise generating a proof of pickup of the second car 10 upon verification of the confirmation number in the system. The driver drives the second vehicle 10 from the fourth car dealer 9 to the third car dealer 12. Typically, a temporary licence plate belonging to the third dealer 9 shall be used with the vehicle 10.

In some embodiments, upon arriving to the third dealer, the driver further removes the licence plate of the second vehicle 10. The license plate is then expedited or sent back to the fourth dealer 9 using any known method 100, such as mailing, courier or another driver returning the plate to the original dealer 9. In some embodiments, the method 100 further comprises generating and/or printing a pre-addressed envelope or box. Such envelope or box is returned back to the fourth dealer 9.

The method 100 further comprises the driver providing the unique number or the pickup confirmation to the third dealer 12. The method 100 further comprises verifying that the identification number or pickup confirmation is valid and issue a delivery confirmation. The verification of the identification number typically comprises inputting the confirmation number into the system which then validates the unique identification number in the data source. Again, the verification of the identification number may trigger the processing of the payments and disbursements associated with the second transport 11.

In some embodiments, the method 100 may further comprise managing the transportation 14 of the driver from the third dealer 12 to the second dealer 2. Again, the method 100 may comprise requesting a transport 14 between the location of the third dealer 12 and the location of the second dealer 2. Understandably, any method 100 for organization such a transport 14 may be used, such as a shuttle 14 provided by the second 2 or third 12 dealer, a taxi or any other type of transportation. The said transport 14 brings the driver back to original car dealer 2.

In embodiments where the driver carries the licence plate of the first vehicle 3, the said licence plate is returned to the second dealer 2 located in the second city 1. Typically, the licence plate is a special licence plate which may be easily removed and used in multiple vehicles to allow driving new or unlicensed vehicles on the road. The driver may then use another vehicle at the second dealer 2 or close by, may take a shuttle or any other public transit to go to another destination.

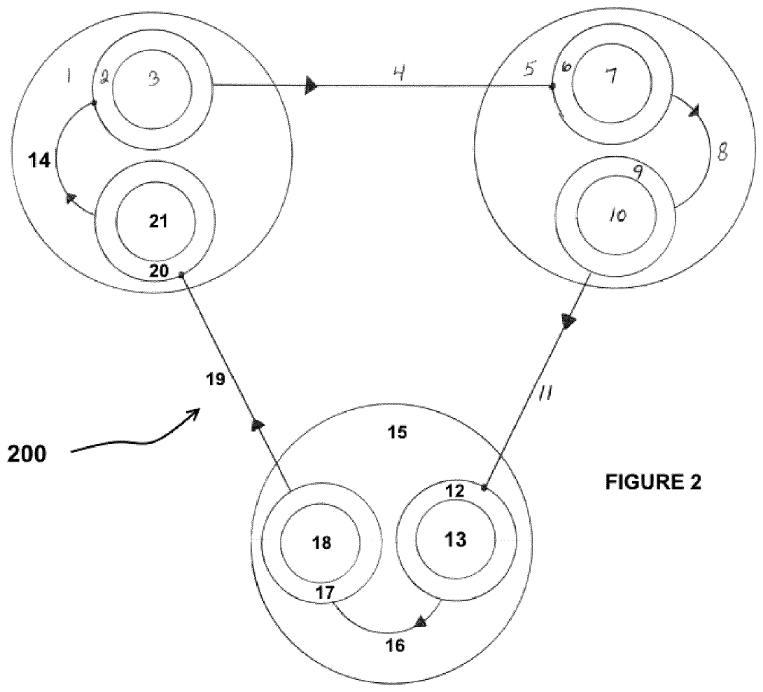

Now referring to FIG. 2, another exemplary embodiment of a method 200 for managing vehicle transportation between dealers located in three cities is illustrated. As illustrated, the method 200 of the present invention may be adapted to manage vehicle transportation between a plurality of car dealers located in any number of cities. The exemplary method 200 is similar to the above described method 100 for managing transportation between dealers of two cities but adapted to be used in three cities. As such, the method now comprises managing 200 three transports or trips 4, 11 and 19, at least three cities 1, 5 and 15 and at least three vehicles 3, 10 and 18.

In such an exemplary embodiment, each car dealer requiring a transport, in this example, car dealers 6, 12 and 20 agrees to buy a car fulfilling the needs of customers to the car dealer having the required cars, such as car dealers 2, 9 and 17. Upon each agreement, one car dealer of each agreement (either the buyer or the seller), registers or creates the transport 4, 11 or 19 to the system.

The method 200 further comprises publishing or displaying each created transport 4, 11 and/or 19 information for other car dealers to access the planned transports 4, 11 and/or 19.

The method 200 comprises matching transports destinations and origins as per the following: the first trip 4 destination being the same as the second trip 11 origin, the second trip 11 destination being the same as the third trip 19 origin, and the third trip 19 destination being the same as the first trip 4 origin. When all conditions are matching, the transports 4, 11 and 19 are matched to create a formalized pairing.

The method further comprises pairing the three transports 4, 11 and 19. In some embodiment, the method 200 may further comprise each owner of the trip confirming the pairing.

Upon pairing the transports 4, 11 and 19, the method 200 may further comprise issuing or generating a confirmation number for the transaction. Such confirmation number typically identifies the different transports 4, 11 and 19.

The confirmation number may be used to validate that each car 3, 10 and 18 have been received by the receiving dealer 6, 12 and 20 associated with the different transports 4, 11 and 19. Such unique number may also be used to identify the payment and disbursement agreements involved in each of the vehicle transfer. Understandably, any known method for identifying the combination of transports may be used such as using a combination of identification number of each transport 4, 11 and 19.

The driver drives the vehicle 3 from the selling dealer 2 of the first transport 4 to the buying dealer 6. Upon arrival, the driver shows or indicates the unique number to the receiving car dealer 6.

The method 200 may further comprise the receiving car dealer 6 inputting the unique number in the system to confirm that the vehicle 3 has been received. The method 200 may further comprise generating a receipt or a confirmation of delivery for the driver. The method 200 may also comprise automatically processing the payments and disbursements associated with the transport 4. Such steps are repeated for the other transports 11 and 19. Understandably, the payment may be triggered only upon receiving confirmation of each of the different transports 4, 11 and 19.

The method 200 further comprises managing the transportation 8 and 16 of the driver from each receiving dealer 6 and 12 to the next respective sending dealer 9 and 17. In some embodiment, the method 200 comprises requesting a transport between the location of the receiving dealer 6 and 12 and the location of the next sending dealer 9 and 17. Understandably, any method for organization such a transport 8, 14 or 16 may be used, such as a shuttle provided by the receiving dealer 6,12 or 20 or the next sending dealer 2, 9 or 17, a taxi or any other types of transportation. The transportation 8 or 16 allows using a single driver and to avoid using multiple drivers for completing the complete trip. The method 200 may comprise the sending and receiving dealers 2/6 or 9/12 agreeing on a transportation mode which is identified in the system when the pairing is formalized.

The method 200 generally further comprises the second and third transports 11 and 19 starting from the second city 15 or third city 1 as the driver reaches the sending dealers 9 and 17. Typically, each sending car dealer 2, 9 and 17 provides a licence plate to the driver to be used with the vehicle 3, 10 or 18 to be delivered.

In some embodiments, the driver removes the licence plate after delivery of each vehicle 3, 10 and 18 to the destination dealer 6, 12 and 20. In yet some other embodiments, the driver carries the removed plates to the last (and original) car dealer 2. Typically, the license plate is then expedited or sent back to the respective sending car dealers 9 and 17 using any known method, such as mailing, courier or another driver returning the plate to the sending dealers 9 and 17. In some embodiments, the method 200 further comprises generating and/or printing a pre-addressed envelope or box for each sending car dealer 9 and 17.

In some embodiments, when the driver reaches the last receiving car dealer 20, the method 200 may further comprise managing the transportation 14 of the driver from the last receiving dealer 20 to the original sending dealer 2. Again, the method 200 may comprise requesting a transport 14 between the location of the last receiving dealer 20 and the location of the first sending dealer 2. Understandably, any method for organization such a transport 14 may be used, such as a shuttle, a taxi or any other types of transportation. The said transport 14 brings the driver back to original car dealer 2.

The driver may then collect a vehicle left or present at the first sending dealer 2 or may take another shuttle or any other public transit to go to another destination.

In other embodiments, the method 200 may be adapted to manage transportation in more than three cities as long as the driver is provided or manage to move from each receiving dealer to the next sending dealer.

A system for managing vehicle transportation between dealers is provided. The system typically comprises a server configured to connect to client devices through a network. The server typically comprises a central processor unit, a memory unit, a storage unit and network unit. The server is configured to execute instructions of a program to manage vehicle transportation between dealers.

In a typical embodiment, a computerized client device, such as a computer, a tablet, a smart phone, a smart watch, a laptop or any other type of computerized device adapted to connect to the server through the network, is configured to send requests to the server. The computerized client device may be configured to run a program, such as a mobile application or a browser, to communicate with the server.

The computerized device is adapted to provide an interface for a user to input the information in relation to a transport, such as the details about the vehicle to be delivered, the time and date of the transport, the sending car dealer, the receiving car dealer, the assigned driver, the applicable disbursements or any other information related to the transport. The computerized device is further adapted to communicate the information to the server and to request the publication of the transport on the server.

The server may further be configured to store paired deliveries and/or paired transports in a data storage, such as a database or data source. In some embodiments, the server is configured to identify deliveries having a point of origin or a point of destination within a predetermined radius, travel distance or travel time from a vehicle dealer not involved in such identified deliveries. As such, based on the identified dealers within the predetermined radius or distance, the system may be configured to communicate or send a message to the identified dealers notifying of a potential or pairable delivery within the area of such identified dealers. Understandably, in such embodiments, the message may be embodied as any type of message such as electronic messages (email, SMS) or as notification within an application or program running on the computerized device of the user.

The server may further be configured to receive a request from a computerized device to identify a desired delivery. Typically, the desired delivery comprises a location of origin, such as details about the dealer of origin, a location of destination, such as details about the dealer of destination and a future date or time range to organize the delivery. In some embodiments, the desired or planned delivery is stored in the data storage of the system. The system and/or server may then be configured to use the planned delivery when calculating potential pairings of deliveries to create a transport having multiple deliveries. The planned delivery may also be displayed or published by the system for a user to manually select the said planned delivery to pair to another delivery.

The computerized device may further be configured for a user to input a confirmation number and to send the confirmation number to the server. Understandably, any method for inputting the confirmation number such as scanning a bar code, a hash tag or any other encoded number may be used.

Also, in some embodiments, the client device of a car dealer (either receiving or sending) may be configured to communicate with the computerized device used by the driver to communicate driving instructions, details about the transport, the unique identification number, etc. In such embodiments, the driving instructions may be calculated by the server or may be calculated by a third-party service, such as Google Maps®.

The computerized device may further be configured to display the driving instructions between a sending car dealer and a receiving car dealer of a transport or to provide localization data.

The server is typically configured to at least publish the details of the transport, to automatically match two or more transports having compatible origins and destinations, to pair matching transports, to generate a unique confirmation number of paired transports, to process payment of the costs and disbursement of a transport, to generate one or more invoices, to validate a received unique confirmation number and to generate confirmation receipts.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A computer-implemented method for managing delivery of vehicles between dealers of vehicles, the method comprising:
a) a first dealer at first location communicating first criteria about a vehicle to be delivered to the first dealer to a server;
b) sending a notification to the first dealer that a second dealer at a second location is in possession of a first matching the entered criteria;
c) pairing the first dealer and the second dealer to create a first delivery;
d) a third dealer within a first predetermined distance from the second location communicating second criteria about a vehicle to be delivered to the third dealer to a server;
e) sending a notification to the third dealer that a fourth dealer within a second predetermined distance from the first location is in possession of a second vehicle matching the entered second criteria;
f) pairing the third dealer and the fourth dealer to create a second delivery;
g) pairing the first delivery to the second delivery to create a transport;
h) associating a driver to the created transport.

2) The computer-implemented method of claim 1, the first and second criteria respectively comprising specifications of the first and second cars to be delivered.

3) The computer-implemented method of claim 1, the first and second criteria respectively comprising location information of first and the third dealers.

4) The computer-implemented method of claim 1, the first and second criteria respectfully comprising a transport date.

5) The computer-implemented method of claim 1, information relating to the first and second deliveries being available to all dealers.

6) The computer-implemented method of claim 1, the method further comprising generating a unique confirmation identification for each of the deliveries or for the transport.

7) The computer-implemented method of claim 1, the method further comprising creating a driver delivery between the fourth and the first dealer.

8) The computer-implemented method of claim 7, the driver delivery being associated with a mode of transportation.

9) The computer-implemented method of claim 1, the method further comprising creating a driver delivery between the first and the third dealer.

10) The computer-implemented method of claim 9, the driver delivery being associated with a mode of transportation.

11) The computer-implemented method of claim 1, the method further comprising automatically processing the payments and disbursements associated with the transport.

12) The computer-implemented method of claim 1, the method further comprising generating a pre-addressed label to return one or more temporary licence plates used in the transport to the respective dealers.

13) A system for managing delivery of vehicles between dealers, the system comprising:
a) a plurality of computerized devices adapted to communicate through a network, each computerized device being configured to:
i) provide an interface for a user;
ii) input criteria about a vehicle to be delivered to a dealer;
iii) receive notifications;
b) a data source, the data source being configured to store:
i) a plurality of dealers, each dealer being associated with a location and details;
ii) a plurality of deliveries, each delivery pairing an origin dealer, a destination dealer and a vehicle to be delivered;
iii) a plurality of transports, each transport pairing at least a first delivery and a second delivery;
c) a server to communicate through the network, the server being configured to:
i) automatically match two or more deliveries where a location of an origin dealer of a first delivery is within a predetermined distance of a destination location of a second delivery;
ii) pair the matching deliveries to form a transport;
iii) generate unique confirmation numbers for each delivery or each paired transport;
iv) send notifications to one or more of the computerized devices when a dealer is in possession of a vehicle matching at least one of the inputted criteria;

14) The system for managing delivery of vehicles of claim 13, the server being further configured to process payments and to generate invoices in relation to each delivery and/or to each transport.

15) The system for managing delivery of vehicles of claim 13, the server being further configured to validate one or more confirmation numbers inputted in one of the computerized devices and communicated to the server.

16) The system for managing delivery of vehicles of claim 13, the server being further configured to calculate driving instructions in relation to at least one of the deliveries to at least one of the computerized devices.

17) The system for managing delivery of vehicles of claim 16, the server being further configured to communicate the driving instructions to at least one of the computerized devices.

18) The system for managing delivery of vehicles of claim 13, the server being further configured to automatically match two or more deliveries having origins and destinations within a predetermined distance.
